(19) United States
(12) Patent Application Publication
(10) Pub. No.: US 2003/0091719 A1
(43) Pub. Date: May 15, 2003

(54) Healthy beverage

(76) Inventor: Bernadino Pavone, Plymouth, MI (US)

Correspondence Address: GIFFORD, KRASS, GROH, SPRINKLE, ANDERSON & CITKOWSKI, PC, 280 N OLD WOODARD AVE, SUITE 400, BIRMINGHAM, MI, 48009, US

(21) Appl. No.: 10/054,215

(22) Filed: Nov. 13, 2001

(51) Int. Cl. A23L 2/00

(52) U.S. Cl. 426/599

(57) ABSTRACT

A healthy beverage contains tomato juice, carbonation, sweetener, vegetable pepper and citrus flavoring. One liter of the beverage provides at least 10% of the USDA recommended adult requirement of vitamin C.

### FIELD OF THE INVENTION

The present invention relates generally to beverages for human consumption and more particularly to that class of beverages which provide certain health benefits.

### BACKGROUND OF THE INVENTION

The beverage industry has undergone significant changes in the last three decades. As consumers have become more health-conscious, beverage producers have sought to provide beverages with improved nutritional content. Consumer acceptance of new beverages, however, is based on numerous factors, only one of which is nutritional benefit. Taste, aroma, appearance and even texture are important factors in determining the success of a new beverage.

One traditional beverage having significant nutritional benefits is tomato juice. Tomato juice is low in calories, an excellent source of vitamin c and provides numerous phytokines, the full nutritional benefits of which are only recently becoming understood. In addition, as a fully natural food substance tomato juice has met with the approval of even the most strident health conscious individuals. Tomato juice per se as well as its variants such as tomato-juice based vegetable beverages, however, are objectionable to many consumers on the basis of taste. This important factor has diminished the capacity of tomato juice to serve as a universal source of nutrition.

It would therefore be desirable to provide a tomato juice-based beverage which has an improved taste.

### SUMMARY OF THE INVENTION

In one aspect the present invention provides a tomato juice-based beverage with is made by combining tomato juice and carbonated water. In another aspect, the beverages also include spices, citrus flavoring and sweetener. In one aspect the spices include vegetable pepper extract and the citrus flavoring includes lemon and lime flavorings.

More specifically, the present invention in its most preferred embodiment provides a beverage which contains from about 10% to about 99% by weight tomato juice, from about 0.10 to about 5.0 volumes carbon dioxide, from about 0.01% to about 20% by weight sweetener, from about 0.01% to about 10% by weight spices and from about 0.01% to about 80% by weight citrus flavoring.

In the most preferred aspect, the present invention is prepared by using commercially available pre-mixed sources of ingredients, more specifically, by combining a citrus soda, preferably a carbonated lemon-lime drink such as “7 UP,” “SPRITE” or SLICE, and most preferably the diet versions of these sodas, with a Bloody Mary base such as Mr. & Mrs. T's Bloody Mary Mix, which contains tomato juice and spices.

### DETAILED DESCRIPTION OF THE PREFERRED EMBODIMENTS

In one embodiment of the present invention, the inventive beverage contains tomato juice and carbonation (dissolved carbon dioxide). The tomato juice component is available from numerous sources or can be prepared simply by reducing whole tomatoes to juice form in the conventional manner. Tomato juice forms from about 10% to about 99%, more preferably form about 20% to about 80% and most preferably from about 40% to about 60% of the beverage of the present invention. The preferred tomato juice content should provide at least 10% of the USDA recommended adult daily requirement of vitamin C in one liter of the final beverage.

The art of beverage carbonation will be understood by those skilled in the art. In the present invention, however, the final composition preferably contains from about 0.10 volumes to about 5.0 volumes dissolved carbon dioxide (e.g., one liter of carbon dioxide dissolved in one liter of beverage equals 1 volume). One preferred method of carbonating the inventive beverage is by flowing gaseous CO₂ through an admixture of the beverage ingredients. The most preferred method, however, is the addition of carbonated water (soda water) as an ingredient of the beverage. Numerous sources of soda water are available such as Schweps.

In another embodiment, sweeteners are added to the carbonated tomato juice. The degree of sweetness of the inventive beverage is a function of sweetener content and the type of sweetener which is used. Most preferably, the sweetener comprises a natural sugar such as sucrose (table sugar) or fructose or combinations thereof, or one of the many fruit sugars such as sorbitol, mannitol, xylitol and maltitol. Alternatively, or in combination with a natural sweetener, artificial sweeteners may be used such as saccharin, cyclamate, aspartame, sucralose and the like. It will be appreciated that a 0.1 Molar solution of sucrose contains 34.2 grams of sucrose per liter of water. In the present invention, the desired sweetness should be equivalent to the sweetness obtained by dissolving from about one-sixteenth cup to about 3 cups of table sugar to one liter of water (preferably purified by reverse osmosis). In other words, regardless of the sweetener used, the final beverage should have a comparable relative sweetness within the above range. In that embodiment in which table sugar is used as the sweetener, from about 10 ml to about 100 ml of sugar per 12 ounces of beverage is utilized. Preferably, the final beverage will contain from about 0.01% to about 20% sweetener.

In still another embodiment, spices are added to the beverage. The main spice used herein is derived from vegetable peppers, preferably hot green peppers, cayenne peppers, chili peppers, jalapeno peppers, habenaro peppers and equivalent hot peppers. The vegetable pepper component may be added as dried powder vegetable peppers, as liquid puree of pepper or as the juice of mashed vegetable peppers. The pepper component may, in the case of dried, powdered cayenne peppers, constitute from about 0.5 gram to about 30 grams per liter of beverage. In the preferred embodiment, the final beverage contains from about 0.01% to about 10% vegetable pepper. (All percentages used herein are percent by weight unless otherwise specified).

Other spices which may be suitable for use in the present invention include table salt (sodium chloride) or a salt substitute, and ground peppercorns. The salt content of the inventive beverage may vary, but will typically be in the range of from about 0.1 gram to about 20 grams per liter of beverage. The ground peppercorn component will typically be within the range of from about 0.1 gram to about 10 grams per liter of beverage. Other spices which may be desirable in a particular formulation are onion powder (from about 0.1 to about 10 grams per liter of beverage), garlic powder (from about 1 to about 10 grams per liter of beverage) and horseradish (from about 1 to about 10 grams per liter of beverage). Although not necessarily classified as a spice, the inventive beverage may further include from about 1 ml o about 20 ml of vinegar per liter of beverage. The preferred beverage of the present invention contains from about 0.01% to about 10% by weight other spices in addition to vegetable peppers.

In one embodiment, citrus flavoring comprises another component of the beverage of the present invention. Most preferred are lemon flavoring and lime flavor, together. Other citrus flavors such as grapefruit or the like may also be suitable The nature of citrus flavoring will be understood by those skilled in the art, but generally, these flavors are generally provided as tinctures. In addition, the citrus flavoring may be provided as citrus juice (e.g., lemon and/or lime juice). In the preferred embodiment, the inventive beverage contains from about 0.01% to about 20% citrus flavoring.

It will be appreciated that the tomato juice component of the present invention includes water; it may, however, be desirable to provide additional water such that the total water content of the inventive beverage may constitute up to 99% by weight of the final beverage.

The following chart sets forth the ranges of ingredients for preferred embodiments of the invention:

| | Preferred | More Preferred |
|---|---|---|
| tomato juice | 10%-99% | 1.0%-99% |
| carbonation | 0.10-5.0 volumes | 0.10-5.0 volumes |
| sweetener | 0.00-20% | 0.01-20% |
| vegetable pepper | 0.00-10% | 0.01%-10% |
| other spices | 0.00-10% | 0.01%-10% |
| citrus flavor/juice | 0.00-20% | 0.01%-20% |

### EXAMPLE

A glass container was provided in which approximately 8 ounces of standard diet 7 UP brand soda and approximately 8 ounces of bloody Mary mix were combined by hand stirring. The resultant beverage was pleasing in taste.

What is claimed is:

1. A beverage which provides a source of vitamin C, said beverage comprising:
tomato juice; dissolved carbon dioxide; sweetener; vegetable pepper; and citrus flavoring in admixture.

2. The beverage recited in claim 1, further comprising salt or salt substitute.

3. The beverage recited in claim 1, wherein said citrus flavoring is selected form the group comprising lemon flavoring and lime flavoring, and combinations thereof.

4. The beverage recited in claim 1, wherein said sugar is selected from the group consisting of natural sweeteners and artificial sweeteners.

5. The beverage recited in claim 1, wherein said sweetener is table sugar.

6. The beverage recited in claim 1, further comprising vinegar.

7. The beverage recited in claim 1, further comprising ground peppercorn.

8. The beverage recited in claim 1, further comprising onion.

9. The beverage recited in claim 1, further comprising garlic.

10. The beverage recited in claim 1, further comprising horse radish.

11. The beverage recited in claim 1, wherein said tomato juice contains water and wherein additional water is present such that the beverage contains up to 99% by weight water.

12. The beverage recited in claim 1, wherein said tomato juice comprises from about 10% to about 99% by weight of said beverage.

13. The beverage recited in claim 1, wherein said tomato juice constitutes from about 10% to about 99% by weight, said carbon dioxide constitutes from about 0.5 volumes to about 5 volumes, said vegetable pepper constitutes from about 0.01% to about 10% by weight, sweetener constitutes from about 0.01% to 20% by weight.

14. The beverage recited in claim 1, wherein said beverage contains up to 99% by weight water.

15. The beverage recited in claim 1, wherein said beverage contains at least 10% of the USDA recommended adult daily requirement of vitamin C.

16. A beverage which provides a source of vitamin C, said beverage comprising:
tomato juice and dissolved carbon dioxide.

17. The beverage recited in claim 16, wherein said tomato juice comprises from about 10% to about 99% by weight of said beverage.

18. The beverage recited in claim 16, wherein said carbon dioxide constitutes from about 0.5 volumes to about 5 volumes.
